(19) United States
(12) Patent Application Publication
(10) Pub. No.: US 2017/0064795 A1
(43) Pub. Date: Mar. 2, 2017

(54) LUMINAIRE FOR ILLUMINATING AN AREA OF A BUILDING, IN PARTICULAR AN OFFICE

(71) Applicant: HERBERT WALDMANN GMBH & CO. KG, Villingen-Schwennongen (DE)

(72) Inventors: Marc STOCKBURGER, Villingen-Schwenningen (DE); Klaus-Jurgen HAHN, Villingen-Schwenningen (DE)

(21) Appl. No.: 15/119,978

(22) PCT Filed: Mar. 11, 2015
(86) PCT No.: PCT/EP2015/055005

§ 371 Date: Aug. 18, 2016

(30) Foreign Application Priority Data
Mar. 11, 2014 (DE) 102014103197.0

(51) Int. Cl. H05B 37/02; F21S 8/08; H05B 33/08; F21V 23/04

(52) U.S. Cl. CPC H05B 37/0272; F21V 23/04; F21V 23/0492; F21S 8/08; H05B 37/0281; H05B 37/0227; H05B 33/0854; H05B 33/0872; F21Y 2115/10

(57) ABSTRACT

A luminaire (10) for illuminating an area of a building, in particular an office, comprising lighting means (14) for providing light, a support means (12) on which the lighting means (14) can be mounted, a control unit (for controlling the lighting means (14) using control commands, a communication means (24) for communicating with the control unit (22), the communication means (24) having a data carrier (26), in which data that can be read out by the control (22) can be stored for the purpose of controlling the luminaire (10), a power source (30) or a power source connection for a power source, having the following additional features: a timing module (28), disposed in or on the luminaire (10), for autonomously supplying the current time and, if appropriate, the current date, and the data stored in the data carrier (26) can be read out in accordance with the time information supplied by the timing module (28) for the time-dependent control of the luminaire (10). The invention further relates to a corresponding lighting system and a corresponding method.

The present invention relates to a luminaire for illuminating an area of a building, in particular an office, comprising lighting means for providing light, a support means on which the lighting means can be mounted, a control unit for controlling the lighting means by means of control commands, and a communication means for communicating with the control unit, the communication means comprising a data carrier in which data that can be read out by the control unit are stored for the purpose of controlling the luminaire. Such luminaires typically also have a power source of their own, or at least a connection for a power source, for supplying the luminaire with power.

Luminaires of this type are also known as “intelligent luminaires” and are used for illuminating areas of buildings, in particular open-plan offices. Frequently, these luminaires also have presence detection means. These means typically consist of a detector for detecting the presence of persons in an area surrounding the luminaire, so that the luminaire can switch on automatically when persons are detected, and after a certain follow-on time, the luminaire can switch off automatically if, after a certain period of time, no persons are detected in the area surrounding the luminaire. In the scope of the description of the present invention, areas of buildings are also meant to include the entry areas of buildings, therefore the luminaire according to the invention may also be located outside of a building.

DE 10 2006 057755 A1 discloses a controllable lighting system having a number of intelligent luminaires which are connected to one another via cables, and which are controlled dependent on daylight or in accordance with the movement of persons or animals present in the area of the lighting system. Also disclosed is a control of the lighting system in which individual lights or groups of lights are dimmed dependent on the position of a person, or are switched off when no user is present in the room. Corresponding control commands for the lighting system as a whole are generated in response to a signal or a lack of a signal indicating the presence of persons or animals.

Another lighting system having a number of intelligent luminaires is described in EP 2048916 B1. In that case, the luminaires are connected to control and/or sensor elements via a wired luminaire network. The essential feature of this luminaire network is that each of the luminaires is equipped with a single-strand or multi-strand data signal line, which is inserted into the power supply rails and is thus a component of the common power supply device. This makes it possible for each of the luminaires to transmit data to the other luminaires via a wired connection. If a control and/or sensor element assigned directly to the luminaire triggers a control signal, the luminaire may act on this control signal autonomously to control the lighting means, but may also forward it to the other luminaires in the network via the wired data transmission channel. The data signal line is configured particularly as a single-wire or multiwire bus.

DE 10 2011 002 478 A1 discloses a wired lighting system.

One problem with such wired, intelligent lighting systems is the fact that the installation effort required is relatively great, and increases the more luminaires are to be integrated into the overall lighting system. Moreover, changes to the lighting system, i.e. a repositioning of the individual luminaires, for example in open-plan offices, or changes between different rooms are difficult. Moreover, a special wired communications channel must he provided in order to even make such an intelligent lighting system possible.

DE 10 2012 204579 A1 describes an intelligent lighting system in which the luminaires communicate wirelessly a communication means. In this case, individual luminaires can be combined into groups, so that only luminaires that are located in a specific section of an open-plan office or on a particular floor of a building are switched on or off or dimmed to a certain illumination level. Here, three illumination levels are stored in the luminaires, for example, and are adjusted according to a fixed set of rules in order to prevent pools of light. For instance, the luminaires can contain detectors, which detect the presence of persons in the area surrounding the luminaires, so that when a person enters the office, the luminaire that is closest to the entry area is switched on first. At that point, the luminaire can be switched to the second illumination level. At the same time, the remaining luminaires are switched to the first illumination level. If the person proceeds to his workspace, those luminaires that detect the presence of the person in their vicinity are switched to the second illumination level. The remaining units are returned to the first illumination level.

The rules according to which the various luminaires are controlled are permanently defined and cannot be changed. Only the assignment of the individual lighting means to a particular group can be changed. A time-dependent control of the luminaires also is not possible.

The object of the present invention is to further develop the luminaires of the aforementioned type in such a way that they can be controlled flexibly and particularly in a time-dependent manner, independently of a lighting or data network.

This object is attained with a luminaire according to claim 1, and with a lighting system according to claim 8 and a method according to claim 9. Advantageous developments are the subject matter of the dependent claims.

The essential feature of the invention is that a timing module capable of independently providing the current time and optionally the current date is provided in or on the luminaire. The data stored in the data carrier, which is preferably detachably mounted on the luminaire, can be read out based on the time information provided by said timing module for the time-dependent control of the luminaire. Since the luminaire according to the invention has a timing module, no external timer is necessary. The luminaire can thus be controlled in a complex, time-dependent manner, without requiring a data or lighting network, that is to say some type of cabling, to be provided outside of the luminaire. The luminaire is therefore autonomous. The time information of the data is synchronized with the current time, and preferably also with the current date. Thus if the data specify that an action is to be executed on a certain date and at a certain time, the control unit will compare the current date and the current time with those specified by the data. If the date and time match, the prescribed action is executed. The control unit converts the data into corresponding control commands, with which the lighting means may be switched on or dimmed, for example, in order to change the illumination level. The lighting means may also comprise a number of LEDs (“light-emitting diodes”), in Which case some of the LEDs are switched on or off to change the illumination level.

Widely differing parameters can be taken into consideration. For example, if the luminaire is used for illuminating an office, the luminaire may be operated differently on weekdays from its operation on weekends or holidays, In addition, office hours may be taken into consideration, so that the luminaire is controlled differently during office hours from outside of office hours. With regard to the date, daylight saving time and standard time can be taken into consideration. When the office is closed, some or all of the lighting means may be switched off. For safety reasons, however, it may be prudent for the luminaires to be switched on for a certain period of time even after office hours, or for the illumination level to be changed at certain intervals.

It is also possible for the color of the light emitted by the lighting means to be changed based on the time of day. For example, the lighting means may be set to emit a blue tone in the morning and an orange tone in the evening, in order to synchronize the lighting with the biorhythms of the people working in the office, that is to say, to create the most natural lighting situation possible during the course of the day. In the following, the timing defined by the data with which the lighting means are controlled, according to the above specifications, will be referred to as the “illumination pattern”.

The data carrier can be permanently mounted and disposed in the luminaire, and the communication means can be embodied as an electric cable. The illumination pattern defined on the data carrier can be defined in the factory, in which case the buyer may be given the opportunity when ordering the luminaires to provide customized specifications, for example with respect to office hours or colors.

The means for detecting the presence of persons in the area surrounding the luminaire, e.g. a detector for detecting the presence of a person in the area surrounding the luminaire, may operate using ultrasound, infrared detection (e.g. by means of passive infrared sensors), radar, or the like. What is important is that persons can be detected even when they are working at their desks and thus have a low level of movement activity.

It is thereby possible to control the luminaire according to the invention so as to provide a level of illumination that is pleasant to people, while at the same time minimizing energy consumption, without requiring an external infrastructure to be present or provided.

In a preferred embodiment, the data carrier is designed as a portable storage medium. In this embodiment, the data carrier is not permanently mounted in the luminaire, and can instead be connected to the luminaire at any time by a user or removed therefrom. This results in the significant advantage that the user can conveniently design the illumination pattern as desired, using a computer and software, and can store the defined illumination pattern on the portable storage medium. He can then connect the portable storage medium to the luminaire, so that the luminaire can be operated using the defined customized illumination pattern. Changes to the illumination pattern can be implemented quickly enough to provide a special illumination pattern for a specific occasion, for example, or to adjust the illumination pattern to changes in office equipment or the arrangement of furniture in the office.

The communication means preferably comprises an SD card slot for insertion of an SD card, a USB port for connecting a USB-enabled device and/or a wireless interface for wirelessly communicating with an appropriately equipped device. Other suitable interfaces that can be used as alternatives to the USB port are also conceivable. The purchaser of the luminaire can also be supplied with software, which the user can use to define the desired illumination pattern on a computer. The defined illumination pattern is then stored on a USB flash drive or an SD card, which is then connected to the luminaire, so that the data are provided to the control unit. In this embodiment example, the USB flash drive or SD card functions as the data carrier, which in this case is portable rather than being permanently located in the luminaire. Alternatively, the computer can be connected directly to the USB port and the illumination pattern can be stored on the data carrier, which is permanently located in or on the luminaire. The same process may also be carried out via the wireless interface, in which case the illumination pattern can be designed, for example, on a smartphone using an app and transmitted via the wireless interface to the data carrier that is permanently disposed in the luminaire, where it can be stored.

It is thereby possible to flexibly and easily design the illumination pattern and transmit it to the luminaire. In addition, the illumination pattern can be easily changed, for example if the luminaire is moved to a different location. The software may have a feature that calculates the energy consumption per unit of time, for example per week or per month, enabling the user to determine and optimize the energy consumption.

In a preferred embodiment, the lumninaire has a transmitting means, with Which the control commands can be transmitted to a number of secondary luminaires, wherein the secondary luminaires can be controlled with the control commands and have a receiving means for receiving the control commands, which communicates with the transmitting means. In this case, the luminaire itself functions as a master luminaire, the transmitting means of which transmits the control commands to the secondary luminaires, which are then operated using the corresponding illumination pattern. This master luminaire effectively teaches the secondary luminaires.

Externally, the secondary luminaires can be identical in configuration to the master luminaire, but do not require their own communication means and their own data carrier, and do not need to be capable of communicating with the external data carrier. The secondary luminaires need only to be configured in such a way that the lighting means of the secondary luminaires can be controlled by means of the control commands received by the receiving means. As a result, the secondary luminaires can be somewhat simpler in design, making them less costly to produce. However, it is equally possible to use software to designate one master luminaire as the actual master luminaire from a number of identical master luminaires and to designate the other master luminaires as secondary luminaires.

Furthermore, the process is simplified for the user if he has to provide the illumination pattern only via the master luminaire. The control commands are preferably transmitted wirelessly to the secondary luminaires, so that the luminaires can be easily installed and their location easily changed. The receiving unit of the secondary luminaires can also be configured such that it can itself transmit signals, which can in turn be received by the transmitting means of the master luminaire. In particular, this enables a specific secondary luminaire to be clearly identified. A specific secondary luminaire can thereby be assigned a different illumination pattern from the master luminaire or another secondary luminaire. Additionally, one or more secondary luminaires may be combined into one or more groups, to which a different illumination pattern is assigned from the master luminaire or other secondary luminaires or other groups. The master luminaire can itself be part of a group. The software that is used to create the illumination pattern can have corresponding features. The user can thereby assign a highly complex illumination pattern individually to each secondary luminaire, each group and/or the master luminaire by inputting the illumination pattern solely via the master luminaire. Thus highly complex illumination patterns can be achieved easily and quickly.

A further aspect relates to a lighting system for illuminating an area of a building, in particular an office, comprising a luminaire according to any of the embodiments discussed above, which has a transmitting means, a number of secondary luminaires that can be controlled by means of the luminaire, wherein the secondary luminaires have a receiving means that communicates with the transmitting means. A customized network of luminaires can be constructed, without requiring any major installation and assembly work. The further advantages and technical effects that can be achieved with the lighting system according to the invention correspond to those that have been described for the luminaire according to the invention.

The object is further achieved by a method for illuminating an area of a building, in particular an office, with a luminaire according to any of the aforementioned embodiments, comprising the following steps:
reading out data, which are stored on the data carrier, by means of the communication means and transmitting these to the control unit,
synchronizing the time information contained in the data with the time provided by the timing module, by means of the control unit,
converting the data into control commands by means of the control unit, and
controlling the lighting means by means of the control unit based on the information provided by the timing module,

With the method according to the invention, it is possible to control the luminaire in a time-dependent manner, autonomously, and independently of a luminaire network or data network, so that a time-dependent illumination pattern can be achieved, which nevertheless requires little energy. In addition, the presence of a person can be taken into consideration, with the lighting means typically being controlled as prescribed by the data only when a person is present in the office. This means, for example, that a stored illumination pattern is output by the luminaire or the lighting means only when the presence of a person in the region of the luminaire is actually detected. For example, if the illumination pattern involves changing the intensity and/or the color of the emitted light within a predetermined time interval during a day, for example 7:00 to 19:00, this will be carried out only if a person is actually detected by the presence detection means in the luminaire. In contrast, if no person is detected in the region around the luminaire, the luminaire will remain in its switched-off state. However, if a person enters the region around the luminaire, the stated illumination pattern will be activated by the luminaire. Thus according to the invention, when the presence of a person is detected, not only is the luminaire switched on, the illumination pattern stored on the mobile data carrier is implemented according to the respective programming in the control unit of the luminaire. Additionally, or independently thereof, it is also possible for other control functions for the luminaire to be stored on the portable data carrier. For example, information as to whether or not the luminaire actually activates its presence detection means at all may be stored in the portable data carrier. For instance, for a certain period of time during the day, typically during office hours, the presence detection means may be set to “highly sensitive”. For all other times, however, the presence detection means is deactivated.

If a person enters in the office at a very unusual time, for example in the middle of the night, the lighting means may intentionally not be actuated, or the lighting means may be intentionally actuated in a manner corresponding to a visual alarm, for example, a flashing red light, to make the presence of the person, who might be a burglar, as uncomfortable for him as possible, and to make others aware of his presence.

Additional advantages and technical effects of the method according to the invention correspond to those that have been described for the luminaire according to the invention.

The method according to the invention is preferably further enhanced in that the lighting means are switched off by means of the control unit as soon as the presence detection means have determined that no persons are present. If no persons will be present in the office during office hours due to a company outing or other event, it is not necessary to deactivate an illumination pattern. Thus energy can be saved by switching off the lighting means. However, it may also be specified that when no persons are present, the lighting means are switched off only during a certain time period. If no persons are present beyond this period of time, the lighting means may be dimmed, for example, to a low illumination level.

A further enhancement of the method according to the invention is characterized by the following steps:
transmitting the control commands to a number of secondary luminaires by means of a transmitting means,
receiving the control commands with a receiving means that communicates with the transmitting means, and
controlling secondary luminaires with the control commands.

The advantages and technical effects that can be achieved thereby correspond with those that have been discussed for the luminaire according to the invention and the secondary luminaires.

A further aspect of the invention relates to the use of the luminaire according to the invention and/or the lighting system according to the invention to illuminate an area of a building, in particular an office.

In the following, the invention will be described in detail in the context of preferred embodiments, with reference to the accompanying drawings. The drawings show

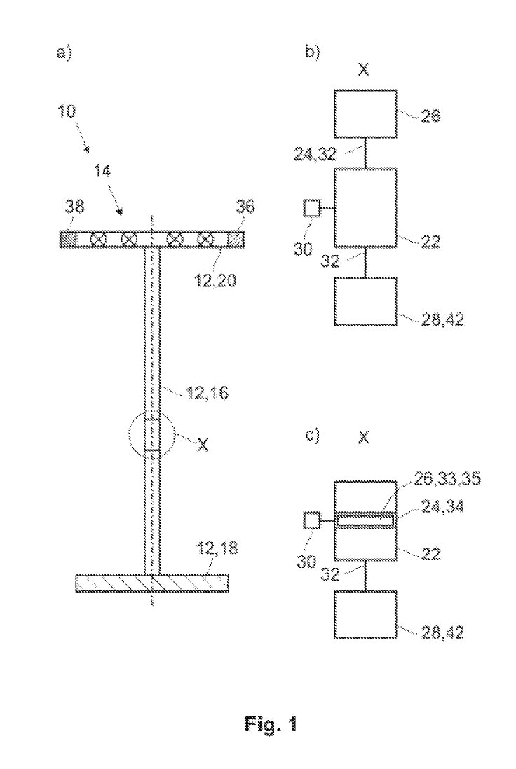

FIG. 1a) a schematic representation of a luminaire according to the invention,

FIG. 1b) a detailed representation of a first embodiment of section X of FIG. 1a),

FIG. 1c) a detailed representation of a second embodiment of section X of FIG. 1a),

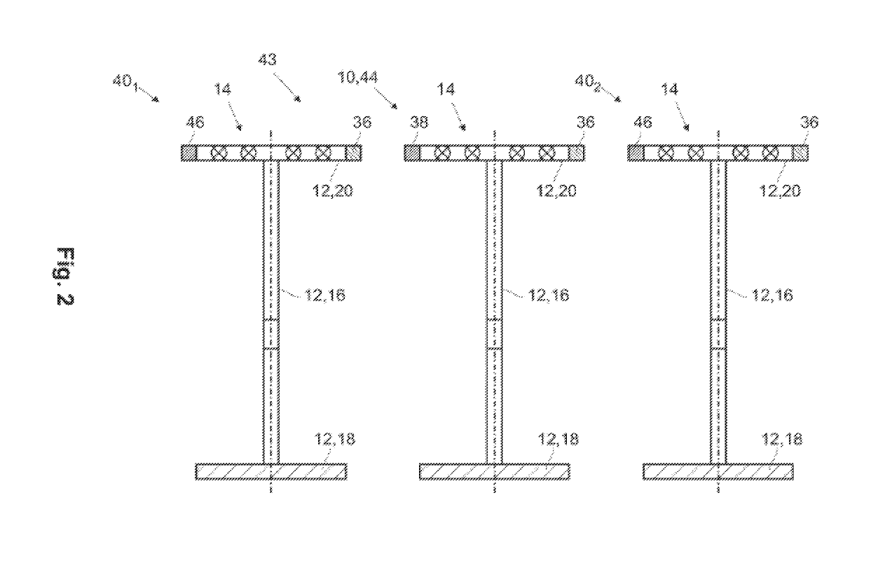

FIG. 2 a schematic representation of a lighting system according to the invention,

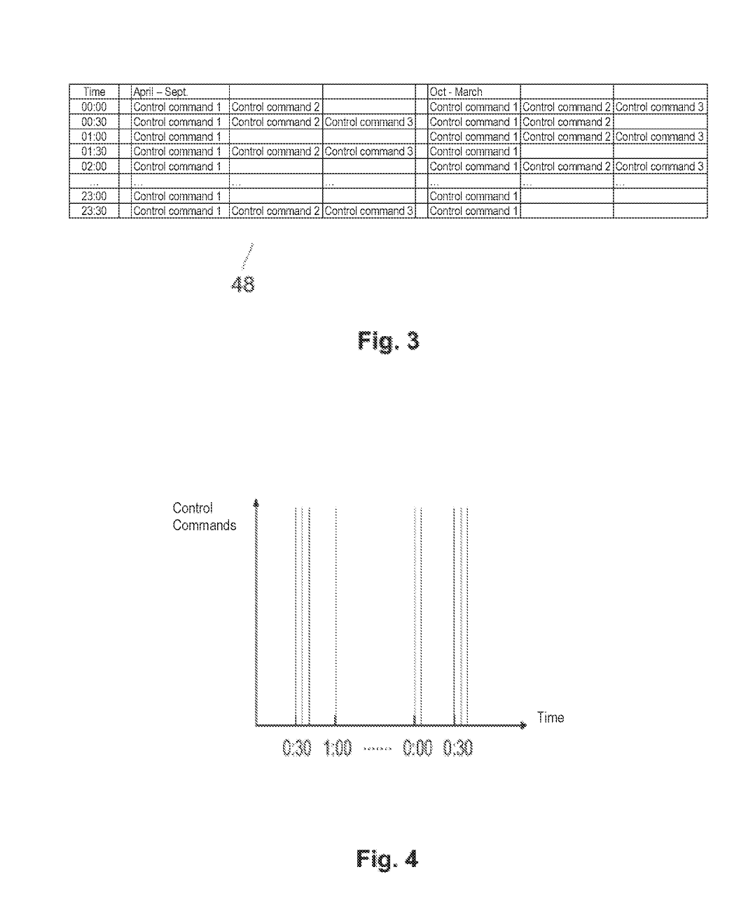

FIG. 3 a table listing control commands according to the concept of the invention,

FIG. 4 a graphic representation of the control commands according to the concept of the invention and

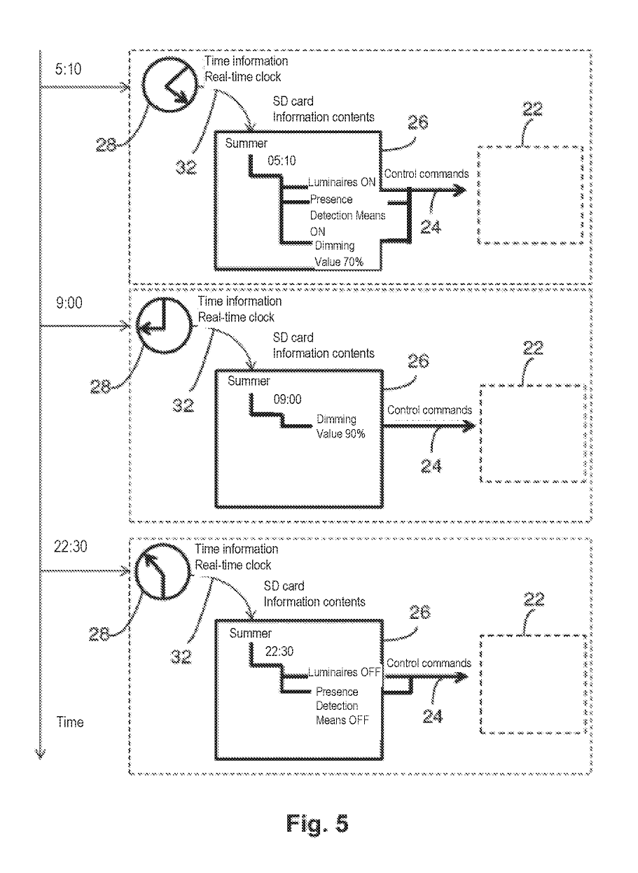

FIG. 5 an example of the actuation of a luminaire based on a daily routine, in accordance with time information stored on an SD card.

FIG. 1a) shows a luminaire 10 according to the invention as represented in a schematic diagram. Luminaire 10 comprises a support means 12, on which a lighting means 14 is mounted. In the example shown, support means 12 comprises a luminaire pole 16, mounted on a luminaire base 18. Support means 12 further comprises a luminaire housing 20, in which lighting means 14, which has four LEDs in the example shown, is disposed. Depending on the design of luminaire housing 20 and the orientation of the LEDs, luminaire 10 emits light upward, downward and/or toward the side. The length of luminaire pole 16 and the design of luminaire base 18 and of luminaire housing 20 may be varied such that luminaire 10 can be used as a floor light, table light, wall light or ceiling light, with the embodiment as a floor light or table light being preferred.

A control unit 22, a communication means 24, a data carrier 26, a timing module 28 and a power source 30 are disposed in luminaire pole 16, and are illustrated in greater detail in FIGS. 1b) and 1c). Power source 30 may be embodied as a battery, an accumulator or a powercap, so that no power outlet is required in order to operate the luminaire according to the invention. In place of power source 30, it is also possible merely to provide connections for a power source, for example an electric power grid. However, in that case luminaire 10 is dependent upon on a power connection being located near luminaire 10. Control unit is used for controlling lighting means 14, for which purpose it generates control commands that are transmitted to lighting means 14 via wires, not shown. Communication means 24 is used for communicating between control unit 22 and a data carrier 26. In FIG. 1b), communication means 24 is embodied as an electric cable 32, and data carrier 26 is located in or on luminaire pole 16.

In FIG. 1c), data carrier 26 is embodied as a portable storage medium 33, with communication means 24 comprising an SD card slot 34, into which the portable storage medium 33 embodied as an SD card 35 can be inserted. SD card slot 34 may be connected to control unit 22 via electric cables, not shown, or via other electrically conductive connections.

Luminaire 10 according to the invention further comprises a detector 36 (see FIG. 1a)), with which the presence of persons within an area surrounding luminaire 10 can be detected. Luminaire 10 according to the invention further comprises a transmitting means 38, with which the control commands can be transmitted to a number of secondary luminaires 40, as will be explained in greater detail in reference to FIG. 2. In addition, luminaire 10 can have a switch, not shown, for manually switching lighting means 14 on and off.

With respect to the embodiment shown in FIG. 1b), luminaire 10 according to the invention is operated as follows: Data that can be read out by control unit 22 are stored on data carrier 26 and can be converted into corresponding control commands. With the control commands, the LEDs of lighting means 14 can be switched on or off, or dimmed, for example. The four LEDs may have different colors, for example white, red, green and blue, so that by appropriately controlling the emitted light, a certain color can be emitted.

In particular, the data contain time information, according to which a specific control command is to be executed at a very specific point in time, that is to say, at a very specific time of day. To enable this, timing module 28 supplies the current time and preferably also the current date. Timing module 28 can be configured as a real-time clock 42, which can have a receiver that can receive a time signal emitted by a time signal transmitter via radio. This enables the real-time clock to be synchronized regularly, similarly to a clock radio, so that the time supplied by timing module 28 is highly accurate. The timing module may also be configured independently of radio clock signals, however, using a timing module that operates on the basis of quartz time, for example. Control unit 22 draws the current time and the current date from timing module 28 in short intervals. As soon as the time information supplied from the data for a specific control command matches the current date and the current time, control unit 22 executes the control command. In this case the data are stored on data carrier 26 in the factory.

In the embodiment shown in FIG. 1c), the procedure is basically the same, but the data are stored on SD card 35, which can be inserted by the user at his discretion into SD card slot 34 and later removed therefrom. Thus in this case, SD card 35 functions as data carrier 26. The user can create customized lighting patterns on a computer using special software, for example, and can store these on SD card 35. He then places SD card 35 into SD card slot 34. Control unit 22 reads out the corresponding data from SD card 35 and converts it to time-dependent control commands. Once again, control unit 22 draws the current time and the current date from timing module 28, so that it can actuate lighting means 14 at the desired time using the control commands.

The data may also factor in the presence of a person in the area surrounding luminaire 10. For instance, certain illumination patterns may he activated only when a person is present in the area surrounding luminaire 10. It is also possible to activate a first illumination pattern when a person is present at a first time and a second illumination pattern when a person is present at a second time. Detector 36 supplies the information as to whether or not a person is present in the area surrounding luminaire 10.

FIG. 2 shows a schematic diagram of a lighting system 43 according to the invention. The system comprises a luminaire 10 according to the invention and a number of secondary luminaires 40. In the example shown, luminaire 10 according to the invention is designated as master luminaire 44. Two secondary luminaires 401 and 402 are also provided. Master luminaire 44 is configured as described above, whereas secondary luminaires 401, 402 have a receiving means 46 in place of transmitting means 38, with which the control commands transmitted by transmitting means 38 are received. Thus a luminaire network is assembled. Although secondary luminaires 40 may also be identical in configuration to master luminaire 44, it is sufficient for the lighting means 14 of secondary luminaires 401, 402 to be controlled by means of the received control commands. In particular, secondary luminaires 401, 402 do not require their own data carrier 26 or their own timing module 28.

As a result, secondary luminaires 401, 402 can be operated using the same illumination pattern as master luminaire 44. It is also possible, however, for secondary luminaires 40 to be operated using a specific illumination pattern only when a person is present in the area surrounding said luminaires. Secondary luminaires 401, 402 may also activate the illumination pattern on a delayed basis, or may activate a different illumination pattern. Receiving means 46 of secondary luminaires 401, 402 may be configured to transmit information, such as its distinct identification, to transmitting means 38 of master luminaire 44. Master luminaire 44 can thus be operated using a first illumination pattern, first secondary luminaire 401 using a second illumination pattern, and second secondary luminaire 402 using a third illumination pattern. It is also possible, however, for the two secondary luminaires 40 or the master luminaire 44 and one of the secondary luminaires 401, 402 to be combined into a group and controlled identically.

In FIG. 3, control commands according to the concept of the invention are presented in tabular form. At a certain time, certain control commands, which are combined to form a segment 48, are executed. The data that are stored on data carrier 26 can thus be segmented. In the example shown, three control commands are combined to form one segment 48. One control command may be to switch lighting means 14 or detector 36 on or off, for example.

It is clear that from April to September at any given time, a different number of commands will be executed from between October and March. This is due to the different lighting conditions during the two periods. However, control command 1, which can switch on detector 36, for example, is always executed. Thus information as to whether or not a person is present in the area surrounding luminaire 10 is always available.

FIG. 4 is a graphic representation of the course over time of a number of the control commands executed between April and September.

FIG. 5 shows one embodiment example of a possible daily routine, illustrating the way in which control unit 22 receives control commands via timing module 28 along with data carrier 26, via communication means 24. Here, the information is stored on mobile data carrier 26, which in this case is an SD card, that at 05:10 the luminaire is to be switched on, a presence detection means is to be switched on, and the luminaire is to have a dimming value of 70% of its maximum luminous value. As soon as timing module 28 signals the time 05:10, corresponding control commands are issued to control unit 22 via communication means 24. Control unit 22 then ensures that the luminaire is switched on, the presence detection means is active and the luminaire is burning with a dimming value of 70%.

In addition, it is programmed as the next set value on the SD card, and thus on data carrier 26, that at 09:00 the dimming value is to be increased to 90%. When timing module 28 supplies the time signal 09:00, a new control command to increase accordingly the luminous value of the luminaire, which is not shown in FIG. 5 for purposes of clarity, is transmitted via communication means 24 to control unit 22.

Finally, additional setting information is stored on data carrier 26, namely at the luminaire is to be switched off at 22:30, along with the presence detection means. When timing module 28 supplies the time information 22:30, corresponding control commands are transmitted via communication means 24 to control unit 22. The luminaire is switched off and the presence detection means in that area is deactivated. The next day at 05:10, as described above, the luminaire is switched back on accordingly, the presence detection means is activated and the luminaire is set to provide a brightness value of 70% of the maximum luminous intensity.

### LIST OF REFERENCE SIGNS

10 luminaire
12 support means
14 lighting means
16 luminaire pole
18 luminaire base
20 luminaire housing
22 control unit
24 communication means
26 data carrier
28 timing module
30 power source
32 electric cable
33 portable storage medium
34 SD card slot
35 SD card
36 detector
38 transmitting means
40, 401, 402 secondary luminaire
42 real-time clock
44 master luminaire
46 receiving means
48 segment

1-11. (canceled)

12. A luminaire (10) for illuminating an area of a building, in particular an office, wherein the luminaire comprises
lighting means (14) for providing light, the color of which may be changed [page 15, lines 25 ff.; page 5, lines 25 ff.],
a support means (12) on which the lighting means (14) can be mounted,
a control unit (22) for controlling the lighting means (14) using control commands,
a communication means (24) for communication between a data carrier (26) and the control unit (22), the communication means (24) having the data carrier (26), in which data that can be read out by the control unit (22) can be stored for the purpose of controlling the luminaire (10),
a power source (30) or a power source connection for a power source,
characterized in that the luminaire has the following additional features:
a timing module (28), disposed in or on the luminaire (10), for autonomously supplying the current time and, if appropriate, the current date,
the data stored in the data carrier (26) can be read out by the communication means (34) based on the time information supplied by the timing module (28) regarding the time-dependent control of the luminaire (10), and can be transmitted to the control unit (22), wherein at least the time supplied by the timing module (28) can be synchronized with the time information contained in the data, by means of the control unit (22), and wherein the time-dependent control of the luminaire involves a time-dependent change in the color of the light emitted by the lighting means [page 15, lines 15 ff.],
the data carrier (26) is embodied as a portable storage medium (33), and
switches for switching the lighting means (14) on and off manually.

13. The luminaire (10) according to claim 12, characterized in that the communication means (24) comprises an SD card slot (34) for inserting an SD card, a USB port for connecting a USB-enabled device, and/or a wireless interface for wirelessly communicating with an appropriately equipped device.

14. The luminaire (10) according to claim 12, characterized in that the luminaire (10) has a transmitting means (38) with which the control commands can be transmitted to a number of secondary luminaires (40), wherein the secondary luminaires (40) can be controlled by the control commands and have a receiving means (46) for receiving the control commands, which communicates with the transmitting means (38).

15. The luminaire (10) according to claim 12, characterized in that the timing module (28) is configured for supplying a seasonally dependent time.

16. The luminaire (10) according to claim 12, characterized in that the luminaire (10) is equipped with means (36) for detecting the presence of persons in the area surrounding the luminaire (10), and in that these presence detection means can be deactivated.

17. The luminaire (10) according to claim 12, characterized in that means are provided for wirelessly teaching other luminaires in the surrounding area.

18. A lighting system for illuminating an area of a building, in particular an office, having a luminaire (10) according to claim 12, which has a transmitting means (38), and a number of secondary luminaires (40) that can be controlled by means of the luminaire (10), the secondary luminaires (40) having a receiving means (46) that communicates with the transmitting means (38).

19. A method for illuminating an area of a building, in particular an office, with a luminaire (10) according to claim 12, comprising the following steps:
connecting the portable data carrier to the luminaire (10),
reading out data, which are stored on the data carrier (26), by means of the communication means (24) and transmitting these to the control unit (22),
synchronizing time information contained in the data with the time provided by the timing module (28), by means of the control unit (22),
converting the data into control commands by means of the control unit (22), and
controlling the lighting means (14) by means of the control unit (22) using the control commands, based on the information provided by the timing module, wherein the color of the light emitted by the lighting means may be changed.

20. The method according to claim 19, comprising the following step:
switching off the lighting means (14) by means of the control unit (22) once the presence detection means (36) located in or on the luminaire (10) has determined that no persons are present.

21. The method according to claim 19 comprising the following additional steps:
transmitting the control commands to a number of secondary luminaires (40) by means of a transmitting means (38),
receiving the control commands by means of a receiving means (46) that communicates with the transmitting means (38), and
controlling secondary luminaires (40) with the control commands.
